(19) United States
(12) Patent Application Publication
(10) Pub. No.: US 2024/0090684 A1
(43) Pub. Date: Mar. 21, 2024

(54) Floral Arrangement Apparatus and a Blank for Forming Same

(71) Applicant: Amy Lovell, Greenbank (AU)

(72) Inventor: Amy Lovell, Greenbank (AU)

(21) Appl. No.: 18/526,812

(22) Filed: Dec. 1, 2023

Related U.S. Application Data
(63) Continuation-in-part of application No. PCT/AU2022/050573, filed on Jun. 10, 2022.

(30) Foreign Application Priority Data
Jun. 12, 2021 (AU) 2021901770

(51) Int. Cl. A47G 7/02

(52) U.S. Cl. CPC A47G 7/02

(57) ABSTRACT

A blank when used for forming a floral arrangement apparatus, the blank being fabricated from a material including at least a pair of layers spaced apart from one another to form a cavity therebetween, the blank including a first panel portion and a second panel portion located adjacent the first panel portion and sharing a common edge therewith, the first panel portion and the second panel portion being configured for folding movement relative to one another about the common edge. In the assembled condition, the first panel portion and the second panel portion are located in abutment with one another such that the cavity is accessible through an aperture in the common edge.

This application is a continuation-in-part application of PCT Application No. PCT/AU2022/050573, filed Jun. 10, 2022, which claimed the benefit of Australian Patent Application No. 2021901770, filed Jun. 12, 2021, which are hereby incorporated by reference.

### TECHNICAL FIELD

The present invention relates to a floral arrangement apparatus and a blank for forming same. In particular the present invention relates to a floral arrangement apparatus configured to retain flowers in place in a floral arrangement.

### BACKGROUND

For many years, florists have used floral foam when creating floral arrangements. Floral foam has the ability to soak up significant quantities of water, meaning that it acts both as a preservative to prolong the life of the flowers and a support to hold them in place.

Conventional floral foam is a thermoset phenolic plastic foam, and contains carcinogenic substances such as formaldehyde, barium sulphates and carbon black. Floral foam is generally considered to be non-biodegradable, and dust generated by dry floral foam can present a health hazard if inhaled.

Further, floral foam dust that enters waterways can create microplastic pollution and can become embedded in the tissue of animals through ingestion or respiration and can potentially be transferred to humans that consume the animals (particularly seafood).

Thus, there would be an advantage if it were possible to provide a floral arrangement product that effectively supported floral arrangements but did not create the potential environmental and health issues associated with floral foam.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a floral arrangement apparatus and blank for forming same which may at least partially overcome at least one of the above-mentioned disadvantages or provide the consumer with a useful or commercial choice.

With the foregoing in view, the present invention in one form, resides broadly in a blank when used for forming a floral arrangement apparatus, the blank being fabricated from a material comprising at least a pair of layers spaced apart from one another to form a cavity therebetween, the blank comprising a first panel portion and a second panel portion located adjacent the first panel portion and sharing a common edge therewith, the first panel portion and the second panel portion being configured for folding movement relative to one another about the common edge, wherein, in the assembled condition, the first panel portion and the second panel portion are located in abutment with one another such that the cavity is accessible through an aperture in the common edge.

The material from which the blank is fabricated may be of any suitable type. Preferably, however, the material comprises a sheet material. The material may be a synthetic material (such as a polymeric material), although the material may be formed at least in part from natural materials. In embodiments of the invention in which the blank is fabricated from a polymeric material, the polymeric material may comprise polyethylene, polypropylene, polyvinyl chloride, polystyrene, polyamide, polytetrafluoroethylene, polychlorotrifluoroethylene, polychloroprene, para-aramid, polyacrylonitrile, polyimide, polyethylene terephthalate and the like, or any suitable combination thereof. In some embodiments, the blank may be fabricated from a combination of one or more synthetic materials and one or more natural materials.

Regardless of the material from which the blank is fabricated, it is envisaged that the material may be substantially non-toxic, non-allergenic and/or biodegradable.

In a preferred embodiment of the invention, the material from which the blank is fabricated may be paper. More preferably, the material from which the blank is fabricated may be cardboard. The cardboard may be of any suitable type, although it will be understood that the cardboard is ideally of sufficient flexibility to be foldable, and of sufficient rigidity to retain its shape in use.

It is envisaged that the cardboard from which the blank is made may be fabricated from any suitable cellulosic material and, more preferably, any suitable natural cellulosic material. For example, the cellulosic material may comprise bamboo, cork, seaweed, mycelium, wood, jute, flax, hemp, sisal, coir or the like, or any suitable combination thereof.

As previously stated, the material comprises at least a pair of layers spaced apart from one another to form a cavity therebetween. Preferably, the pair of layers are fabricated from a sheet material, and the layers may be spaced apart using any suitable technique. However, it is envisaged that, in embodiments of the invention in which the material comprises cardboard that the pair of layers may be spaced apart by, for instance, a pair of sidewalls interconnecting the pair of layers.

In another embodiment, the cardboard may be corrugated cardboard. Any suitable corrugated carboard may be used, including single wall cardboard (which comprises a pair of layers of cardboard sheet material spaced apart from one another by fluted material), double wall cardboard which comprises a pair of outer layers of cardboard sheet material, an intermediate layer of cardboard sheet material located between the pair of outer layers, and fluted material located between each of the pair of outer layers and the intermediate layer. In some embodiments, the carboard may be triple wall carboard comprising a pair of outer layers of cardboard, a pair of intermediate layers of cardboard sheet material located between the pair of outer layers, and fluted material located between each of the layers and its adjacent layer.

Preferably, the fluted material and the intermediate layers of cardboard sheet material (where present) may be located within the cavity defined by the pair of outer layers.

The first panel portion and the second panel portion may be of any suitable size and shape. It will be understood that the size and shape of the first panel portion and the second panel portion may vary depending on the desired shape of the floral arrangement apparatus in the assembled condition. In a preferred embodiment of the invention, however, the first panel portion and the second panel portion may be substantially square or rectangular in shape. The first panel portion and the second panel portion may be of different sizes to one another or may be of substantially the same size as one another.

Preferably, the blank is formed from a unitary structure, although it is envisaged that the blank could be formed from two or more pieces configured for connection to one another.

In a preferred embodiment of the invention, the common edge between the first panel portion and the second panel portion may be defined by a crease, score line or the like. Thus, the first panel portion and the second panel portion may be foldable relative to one another along the crease or score line defining the common edge therebetween.

In some embodiments of the invention, the blank may comprise a third panel portion. Preferably, the third panel portion may be located adjacent the second panel portion and may share a common edge therewith. In this embodiment, the second panel portion and the third panel portion may be configured for folding movement relative to one another about the common edge. Preferably, the common edge of the second panel portion and the third panel portion may be located substantially parallel to the common edge of the first panel portion and the second panel portion. Thus, the panel portions may be positioned in a substantially linear manner in relation to one another.

It is envisaged that any suitable number of panel portions may be provided, and it will be understood that the number of panel portions may be determined by, for instance, the size of the floral arrangement to be assembled using the floral arrangement apparatus and so on. In this embodiment, it is envisaged that a fourth panel portion may be located adjacent the third panel portion and may share a common edge therewith, while a fifth panel portion may be located adjacent the fourth panel portion and may share a common edge therewith and so on. Preferably, therefore, each common edge between adjacent panel portions may be substantially parallel to the other common edges.

In some embodiments, the blank may comprise two or more elongate members. It is envisaged that each elongate member may be formed from two or more panel portions. In this embodiment, a first elongate member may be located adjacent a second elongate member and may share a common edge therewith. Preferably, the first elongate member and the second elongate member may be configured for folding movement relative to one another about the common edge. In some embodiments, the blank may further comprise a third elongate member located adjacent the second elongate member and may share a common edge therewith. The second elongate member and the third elongate member may be configured for folding movement relative to one another the common edge. Further elongate members may be provided in a similar manner.

Preferably, the common edges between the elongate members may be substantially parallel to one another. Preferably, the common edge between the elongate members may be substantially perpendicular to the common edges between the panel portions. In a preferred embodiment of the invention, the common edges of the panel portions on a first elongate member may be substantially aligned with the common edges of the panel portions on each elongate member in a blank.

In embodiments of the invention in which two or more elongate members are present, it is preferred that each of the two or more elongate members includes the same number of panel portions.

As previously stated, the first panel portion and the second panel portion are configured for folding movement relative to one another. In the assembled condition, the first panel portion and the second panel portion are located in abutment with one another. Preferably, an outer layer of the first panel portion is located in abutment with an outer layer of the second panel portion. Thus, it is envisaged that, in the assembled condition, each panel portion is folded approximately 90° relative to its position in the blank. In this embodiment, a face of the first panel portion may be located in face-to-face abutment with a face of the second panel portion. Preferably, the first panel portion and the second panel portion may be in abutment with one another across substantially the entire face of the respective first and second panel portions.

Preferably, each panel portion may be folded relative to adjacent panel portions such that, in the assembled condition, the panel portions in the floral arrangement apparatus are in alignment with one another. In other words, the periphery of each of the panel portions is substantially aligned with the periphery of all other panel portions. Thus, the peripheries of the panel portions together form the periphery of the floral arrangement apparatus in the assembled condition. In this way, the midpoint of each panel portion lies substantially on a common axis.

As previously stated, the cavity is accessible through an aperture in the common edge between the first panel portion and the second panel portion. The aperture may be provided using any suitable technique. For instance, the blank may be formed with apertures therein. In this embodiment, the blank may be cut, torn, pierced or the like in the region of the common edge such that, when the panel portions are folded relative to one another, the aperture is located on the periphery of the floral arrangement apparatus. Alternatively, a portion of the blank in the region of the common edge may be removed (such as by cutting, stamping or the like).

In other embodiments of the invention, the common edge may be provided with a frangible portion that, as the panel portions are folded relative to one another, may tear, rip or otherwise break, thereby exposing the cavity.

In embodiments of the invention in which three or more panel portions are provided, it is envisaged that at least a portion of the common edges between adjacent panel portions may be provided with an aperture therein. In some embodiments of the invention, the apertures may all be provided on the same face of the floral arrangement apparatus. For instance, in embodiments of the invention in which the panel portions are substantially square or rectangular in shape, the floral arrangement apparatus may be substantially cubic or cuboid, respectively, in shape. In these embodiments of the invention, it is envisaged that each of the apertures may be located in the same face of the floral arrangement apparatus and, in particular, in the face of the floral arrangement apparatus configured to face generally upwardly when the floral arrangement apparatus is in use. In a particular embodiment, all of the common edges located on an upper face of the floral arrangement apparatus may be provided with apertures therein. In an alternative embodiment of the invention, each of the common edges located on a lower face of the floral arrangement apparatus may also be provided with apertures therein. Thus, one or more passageways may extend through the floral arrangement apparatus, with a first entrance to the one or more passageways in a lower face of the floral arrangement apparatus and a second entrance in the upper face of the floral arrangement apparatus.

Thus, in embodiments of the invention in which three or more panel portions are present, it is envisaged that the floral arrangement apparatus may, in the assembled condition, comprise a plurality of discrete cavities. In this embodiment, a discrete cavity may be formed in at least a portion of the panel portions. More preferably, a discrete cavity may be formed in each panel portion within the floral arrangement apparatus. It will be understood that the term “discrete cavity” is intended to refer to a cavity that is not in communication with any other cavity within the panel portion. Thus, the panel portion may comprise a plurality of discrete cavities that are not in communication with one another (i.e., they may be spaced apart from one another, or may be adjacent to one another but separated from one another by a wall member or the like.

In some embodiments, an aperture may be provided in each common edge between adjacent panels. In other embodiments of the invention, an aperture may only be provided between every second common edge between adjacent panels. For instance, an aperture may be provided in the common edge between first and second panel portions, third and fourth panels member, fifth and sixth panel portions and so on. It is envisaged that, in this embodiment, adjacent panels may be folded in such a way that the common edges provided with an aperture may form part of the upper surface of the floral arrangement apparatus, while the common edges between the other panel portions are folded in such as way that they form part of the lower surface of the floral arrangement apparatus.

In some embodiments of the invention, at least a portion of the common edges of the panel portions that form part of the lower surface of the floral arrangement apparatus may also have apertures therein. Thus, in this embodiment of the invention, it is envisaged that one or more passageways may be formed through the floral arrangement apparatus between the apertures in the common edges of the upper surface and the apertures in the common edges of the lower surface. In embodiments of the invention in which the floral arrangement apparatus is located within a container holding a quantity of liquid (such as water), it is envisaged that the stems of flora may be inserted into the apertures in the upper surface of the floral arrangement apparatus and may pass through the apertures in the lower surface of the floral arrangement apparatus. In this way, the cut end of the stem of the flora may be placed directly into the liquid in the container.

In the assembled condition, it is envisaged that a floral arrangement may be arrange by inserting the components of a floral arrangement (e.g., the stems of flora, such as flowers and foliage, card holders, sticks to which balloons are attached and so on) into the cavity within the panel portions through the apertures in the face of the floral arrangement apparatus. The stems of the flora may be held in place through a frictional engagement with the layers of sheet material and/or fluted material within the cavity. It is envisaged that the floral arrangement may comprise freshly-cut flora, flora including root systems, or dried flora.

It is envisaged that, in the assembled condition, the outer surface of the floral arrangement apparatus may include an outer surface of a first panel portion and an outer surface of a second panel portion. In this embodiment, it is envisaged that the outer surface of the first panel portion and the second panel portion may comprise a face of the panel portion (as opposed to the periphery or edge of the panel portion). In embodiments of the invention in which a plurality of panel portions is present, it is envisaged that a portion of the faces of the panel portions may be located in abutment with one another at the interior of the floral arrangement apparatus. However, a face of each of a first panel portion and a second panel portion may form the outer surface of the floral arrangement apparatus. It is envisaged that the panel portions may be located at opposed ends of the floral arrangement apparatus to one another.

In some embodiments of the invention, one or more apertures may be provided in the outer surface of the floral arrangement apparatus (and, more specifically, in the faces of the panel portions forming the outer surface of the floral arrangement apparatus). Preferably, the apertures in the faces of the panel portions are connected to one or more cavities formed in the interior of the panel portion. In this embodiment, it is envisaged that one or more items of flora may be received in the apertures provided in the faces of the panel portions. This may be of particular use in instances where, for instance, the floral arrangement apparatus is located on a relatively flat surface (such as a tray, plate or the like), or a surface on which at least a portion of the faces of the panels are exposed, so that flora may extend from more than just the periphery of the floral arrangement apparatus.

In some embodiments, apertures may be located in panel portions other than the panel portions that form the outer faces of the floral arrangement apparatus. In this way, even though the faces of some panel portions may not form part of the outer surface of the floral arrangement apparatus, apertures may be provided that are in communication with apertures in one or more adjacent panel portions.

In some embodiments of the invention, apertures in adjacent panel portions may be configured to substantially align with one another when the floral arrangement apparatus is in the assembled condition. In this way, a substantially linear passageway may be formed through two or more of the panel portions.

The apertures may be of any suitable shape. For instance, the apertures may be in the form of circles, ovals, squares, triangles, rectangles, diamonds or any other suitable shape. In some embodiments, the apertures may be of sufficient size to receive a plurality of items of flora therein. In other embodiments, the apertures may be of sufficient size to receive only a single item of flora therein.

In some embodiments of the invention, the apertures may be provided in the form of slits, incisions or the like. It is envisaged that, as an item of flora is inserted into the floral arrangement apparatus through the slit or incision, the edges of the slit of incision may abut the item of flora, thereby retaining the item of flora in place.

The floral arrangement apparatus may be retained in the assembled condition using any suitable technique. For instance, one or more retention members may be used to retain the floral arrangement apparatus in the assembled condition and to prevent the panel portions from moving out of abutment with one another. Any suitable retention members may be used, such as, but not limited to, one or more mechanical fasteners (screws, bolts, nails, pins, staples or the like), or one or more resiliently deformable members (elastic bands and the like). In some embodiments, an adhesive may be used to retain the panel portions in place in abutment with one another.

In an alternative embodiment of the invention, the assembled floral arrangement apparatus may be located within a container for use. Any suitable container may be used, such as, but not limited to, a bowl, vase, box, jar, moulded cardboard receptacle, or a sustainable holder (made from cardboard or similar sustainable material) or the like. In this embodiment, it is envisaged that the floral arrangement apparatus may be retained in frictional engagement with an inner surface of the container, thereby reducing or eliminating the ability of the panels of the floral arrangement apparatus to move out of abutment with each other. The floral arrangement may be in direct frictional engagement with the inner surface of the container, or may be in indirect frictional engagement. In this embodiment, it is envisaged that an intermediate material, such as paper, tissue paper, fabric or the like, may be located between the floral arrangement apparatus and the inner surface of the container. In a particular embodiment of the invention, the intermediate material may be fabricated from a water-resistant or waterproof material. Any suitable water-resistant or waterproof material may be used, such as waxed paper, waterproof cardboard or similar sustainable material, polymeric sheet material, or the like. In a specific embodiment of the invention, the intermediate material may comprise cellophane, and in particular a water-resistant or waterproof cellophane. Preferably, the intermediate material may be recyclable, biodegradable and/or compostable.

In some embodiments of the invention, the material from which the floral arrangement apparatus is fabricated may be water resistant or waterproof. In this embodiment, the material itself may have water resistant or waterproof properties, or the material may be treated to give the material water resistant or waterproof properties. For instance, the material may be at least partially coated in, or impregnated with, a water resistant or waterproof material, such as a polymeric material, wax or the like. In this embodiment, it is envisaged that a quantity of water may be poured into the floral arrangement apparatus and the stems of at least a portion of the flora in the floral arrangement may be located within the water in the apparatus. In this way, the life of the flora in a floral arrangement may be extended.

In some embodiments of the invention, the floral arrangement apparatus may be provided with one or more substances configured to extend the life of the floral arrangement. Any suitable substances may be provided, such as fertilisers, colour enhancers, a hydrating solution, a postharvest solution, flower food or the like. It will be understood that the term “flower food” refers to a mixture of substances configured to maintain the condition and extend the longevity of cut flowers. Typically, flower food may comprise sugar, an acid (such as citric acid) and a biocide (such as bleach). The one or more substance may be located within the cavity in the apparatus, or the apparatus may be impregnated in, or coated onto, the apparatus.

It is envisaged that the floral arrangement apparatus may be provided to consumers in the form of the blank. In this embodiment, it is envisaged that the consumer may be required to assemble the floral arrangement apparatus themselves for use. Alternatively, the floral arrangement apparatus may be provided to consumers in the assembled condition. In this embodiment of the invention, the floral arrangement apparatus may be provided to the consumer in a ready-to-use condition.

In a second aspect, the invention resides broadly in a floral arrangement apparatus assembled from the blank according to the first aspect of the invention.

In a third aspect, the invention resides broadly in a floral arrangement apparatus, the floral arrangement apparatus comprising a plurality of panel portions located in substantial alignment with one another, such that a periphery of each of the panel portions forms a periphery of the floral arrangement apparatus, each panel portion being fabricated from a material comprising at least a pair of layers spaced apart from one another to form a cavity therebetween, and wherein an aperture is provided in the periphery of at least a portion of the plurality of panel portions, such that the cavity in each of the panel portions is accessible through the aperture.

It is envisaged that the floral arrangement apparatus may be provided to a consumer in the form of a blank to be assembled into the floral arrangement apparatus. Alternatively, the floral arrangement apparatus may be pre-assembled and provided to a consumer in the assembled condition.

Although the floral arrangement apparatus could potentially be used on multiple occasions, it is envisaged that the floral arrangement apparatus of the present invention may be a single use item.

It is envisaged that the floral arrangement apparatus may be used for other purposes. For instance, the floral arrangement device may be used as a space filling or packing device. In these embodiments, the floral arrangement apparatus may be located within a container (such as a postal container, a vessel for holding solids or liquids, a container for packing consumer goods and so on) and may be configured to reduce or eliminate movement of the contents of the container (such as during shipping). Preferably, the floral arrangement apparatus may be located between at least a portion of the contents of the container and an inside surface of the container. In some embodiments of the invention, the floral arrangement apparatus may be located in an ullage space within a container.

In some embodiments of the invention the blank may be configured to be separated into two or more blanks. In this embodiment, it is envisaged that a first blank may be separated from a second blank by separating the first blank and the second blank from one another along a common edge between panel portions. The first blank and the second blank may be separated from one another using any suitable technique. For instance, the first and second blank may be separated from one another by tearing, cutting, ripping or the like. In some embodiments of the invention, one or more common edges of the blank may be provided with perforations, frangible portions, or the like, thereby facilitating the ready separation of the first blank from the second blank along the common edge.

The first and second blank may each be formed into a floral arrangement apparatus. Alternatively, the first blank and second blank may be separated to reduce the overall size of the floral arrangement formed from the first blank or the second blank. Thus, a user may customise the size of the floral arrangement apparatus to suit the size of a floral arrangement and/or the container in which the floral arrangement apparatus is located.

In some embodiments, at least one of the panel portions of the blank may be provided with two or more folding portions. In this embodiment of the invention, it is envisaged that the two or more folding portions of the panel portion may be folded relative to one another so as to reduce and/or shape the size of the panel portion. For instance, the panel portion may be provided with a pair of folding portions configured to be folded relative to one another. In embodiments of the invention in which each of the pair of folding members comprises approximately half of the panel portion, it is envisaged that folding the folding members relative to one another may halve the size of the panel portion. This may be of use in situations in which relative small floral arrangements are required, or in situations in which the floral arrangement apparatus is to be located in a relatively small container or vessel.

In the assembled condition, the first folding portion and the second folding portion are located in abutment with one another. Preferably, an outer layer of the first folding portion is located in abutment with an outer layer of the second folding portion. Thus, it is envisaged that, in the assembled condition, each folding portion is folded approximately 90° relative to its position in the blank. In this embodiment, a face of the first folding portion may be located in face-to-face abutment with a face of the second folding portion. Preferably, the first folding portion and the second folding portion may be in abutment with one another across substantially the entire face of the respective first and second folding portions.

It is envisaged that each panel portion may comprise a plurality of folding portions. Preferably, incisions, score lines or perforations may be provided between adjacent folding portions so as to facilitate the ready folding of the folding portions relative to one another.

Preferably, when the folding portions are folded relative to one another, a cavity is formed along a common edge between the first folding portion and the second folding portion. Preferably, the first folding portion and the second folding portion are located in abutment with one another such that the cavity is accessible through an aperture in the common edge therebetween.

In a fourth aspect, the invention resides broadly in a space-filling or packing device, the device comprising a plurality of panel portions located in substantial alignment with one another, such that a periphery of each of the panel portions forms a periphery of the device, each panel portion being fabricated from a material comprising at least a pair of layers spaced apart from one another to form a cavity therebetween, and wherein an aperture is provided in the periphery of at least a portion of the plurality of panel portions, such that the cavity in each of the panel portions is accessible through the aperture.

It is envisaged that space-filling or packing device may be located within a container (such as a postal container, a vessel for holding solids or liquids, a container for packing consumer goods and so on) and may be configured to reduce or eliminate movement of the contents of the container (such as during shipping). It is envisaged that the device may achieve this by filling empty space within the container. Preferably, the device may be located between at least a portion of the contents of the container and an inside surface of the container. In some embodiments of the invention, the device may be located in an ullage space within a container.

It is envisaged that the space-filling or packing device may provide packing for specific portions of a container. For instance, in some embodiments of the invention, the space-filling or packing device may be configured to be located in a corner of a container. Thus, in this embodiment, the space-filling or packing device may, when assembled, be L-shaped or triangular. In some embodiments, the space-filling or packing device may be provided with a cut-out portion configured to accommodate a part of an object to be held within the container such a bottle or the like.

It is envisaged that the space-filling or packing device configured for use in applications in which it is not located within a container. For instance, the space-filling and packing device may be used as a separator or spacer, such as a separator or spacer for crockery, glass, picture frames, mirrors, and so on. In these embodiments, the space-filling or packing device may be configured to reduce or eliminate movement of objects relative to one another (such as during shipping, in a vehicle or the like). It is envisaged that the device may achieve this by filling empty space between objects. Preferably, the device may be located between at least a portion of the objects. In some embodiments, the device may be positioned in abutment with at least one of a pair of adjacent objects.

It is envisaged that the space-filling or packing device may provide separation between two or more panel like or flat items (such as posters, photographs, books, documents, construction panels, sheets of wood or plasterboard and so on).

It is envisaged that the space-filling or packing device may be provided to consumers in the form of the blank. In this embodiment, it is envisaged that the consumer may be required to assemble the device for use. Alternatively, the space-filling or packing device may be provided to consumers in the assembled condition. In this embodiment of the invention, the space-filling or packing device may be provided to the consumer in a ready-to-use condition.

In some embodiments of the invention, the device may be used for ullage in items such as vases and the likes.

It is envisaged that the space-filling or packing device may provide various shapes in the assembled condition. The folded form of the space-filing or packing-device may provide packing, barrier, or dividing purposes in the form of any suitable shape. For example, the space-filling or packing device in the assembled condition may resemble a Z-shape, a U-shape, a zig-zag shape, or the like.

The present invention provides numerous advantages over the prior art. In particular, the present invention is configured to replace the use of conventional floral foam the use of which, as previously discussed, is associated with a number of health and environmental drawbacks. Thus, the advantages of the present invention include that it is one or more of non-toxic, biodegradable, non-allergenic or compostable. In addition, when fabricated from a cellulosic material, the floral arrangement apparatus is fabricated from renewable and/or recycled materials.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIGS. 1A to 1C illustrate blanks for forming a floral arrangement apparatus according to embodiments of the present invention.

FIG. 2 illustrates a step in the process of forming a floral arrangement apparatus from a blank according to an embodiment of the present invention.

FIG. 3 illustrates a floral arrangement apparatus according to an embodiment of the present invention.

FIG. 4 illustrates a floral arrangement apparatus according to an embodiment of the present invention when in use.

FIG. 5 illustrates a floral arrangement apparatus according to an embodiment of the present invention when in use.

FIG. 6 illustrates a blank for forming a floral arrangement apparatus according to an alternative embodiment of the present invention.

FIG. 7 illustrates a blank for forming a space-filling and packing device according to an embodiment of the present invention.

### DETAILED DESCRIPTION

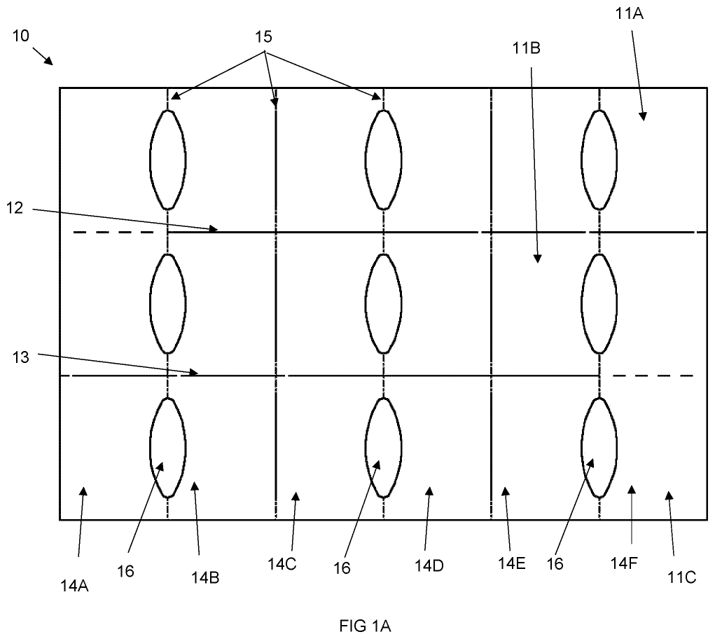

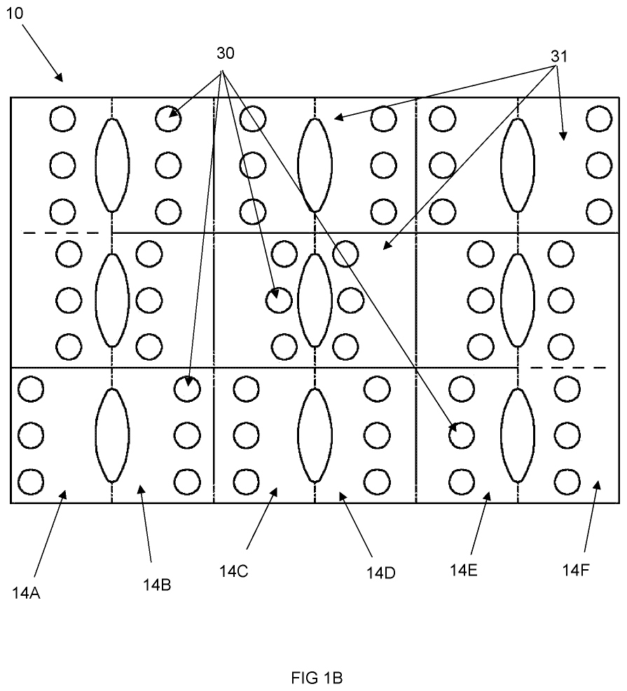

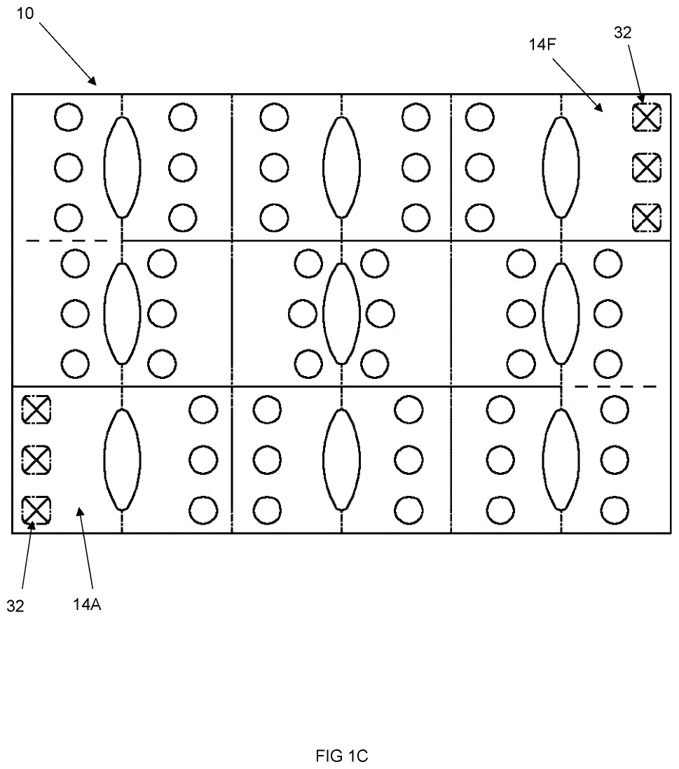

FIG. 1A illustrates a blank 10 for forming a floral arrangement apparatus according to an embodiment of the present invention. The blank 10 comprises three elongate members 11A, 11B, 11C positioned adjacent to one another and comprising a common edge 12 between the first elongate member 11A and the second elongate member 11B, and a common edge 13 between the second elongate member 11B and the third elongate member 11C. The common edges 12, 13 are positioned parallel to one another.

The common edges 12, 13 between elongate members 11A, 11B, 11C are provided as score lines so that the elongate members 11A, 11B, 11C may be folded relative to one another along the common edges 12, 13.

Each of the elongate members 11A, 11B, 11C is divided into six panel portions 14A, 14B, 14C, 14D, 14E, 14F that are located in a linear arrangement so that each panel portion 14A, 14B, 14C, 14D, 14E, 14F shares a common edge 15 with each adjacent panel portion 14A, 14B, 14C, 14D, 14E, 14F. The common edges 15 between panel portions are located parallel to one another and substantially perpendicular to the common edges 12, 13 between the elongate members 11A, 11B, 11C.

Every second common edge 15 between the panel portions 14A, 14B, 14C, 14D, 14E, 14F is provided with an aperture 16 stamped or punched out of the blank 10. The apertures 16 lie along a portion of the common edges 15 between every second common edge 15 (i.e., between the first panel portion 14A and the second panel portion 14B, between the third panel portion 14C and the fourth panel portion 14D, and between the fifth panel portion 14E and the sixth panel portion 14F). However, it will be understood that an aperture will be formed along each common edge, with the apertures formed in common edges not provided with an aperture 16 stamped or punched out of the blank 10 being formed by tearing or ripping along the common edge as the panel portions are folded relative to one another.

In the assembled condition, common edges 15 provided with an aperture 16 will form a lower surface of the floral arrangement apparatus (not shown in this Figure) while common edges 15 provided with an aperture not provided with an aperture 16 stamped or punched out of the blank 10 (i.e., those between the second panel portion 14B and the third panel portion 14C, and between the fourth panel portion 14D and the fifth panel portion 14E will form an upper surface of the floral arrangement apparatus).

The blanks 10 illustrated in FIGS. 1A to 1C are fabricated from single wall cardboard (i.e., cardboard with a pair of opposed outer faces with a cavity therebetween, the pair of opposed outer faces being spaced apart by fluted material).

FIG. 1B illustrates a blank 10 for forming a floral arrangement apparatus according to an embodiment of the present invention. The blank 10 of FIG. 1B is similar to that of FIG. 1A with the exception that the blank 10 of FIG. 1B includes a plurality of apertures 30 in the faces 31 of the panel portions 14A, 14B, 14C, 14D, 14E, 14F. The apertures 30 are located in the panel portions 14A, 14B, 14C, 14D, 14E, 14F so that, as the panel portions 14A, 14B, 14C, 14D, 14E, 14F are folded relative to one another to form the floral arrangement apparatus, the apertures 30 on adjacent panel portions 14A, 14B, 14C, 14D, 14E, 14F substantially align with one another. This allows flora (not shown in this Figure) to be inserted into the floral arrangement apparatus through apertures 30 in the faces 31 of the panel portions 14A, 14B, 14C, 14D, 14E, 14F that form an outer surface of the floral arrangement apparatus. In addition, by aligning the apertures 30 in adjacent panel portions 14A, 14B, 14C, 14D, 14E, 14F, a substantially linear passageway is formed into the body of the floral arrangement apparatus, allowing the flora to be inserted into the floral arrangement apparatus a sufficient distance to ensure that it is retained in place within the floral arrangement apparatus.

FIG. 1C illustrates a blank 10 for forming a floral arrangement apparatus according to an embodiment of the present invention. The blank 10 of FIG. 1C is similar to that of FIG. 1B with the exception that a portion of the apertures in the blank 10 of FIG. 1C comprise incisions 32 in panel portions 14A and 14F. The incisions 32 allow an item of flora to be inserted into the floral arrangement apparatus through the incision 32 such that the edges of the incision abut the item of flora, thereby holding the item of flora in place within the incision 32.

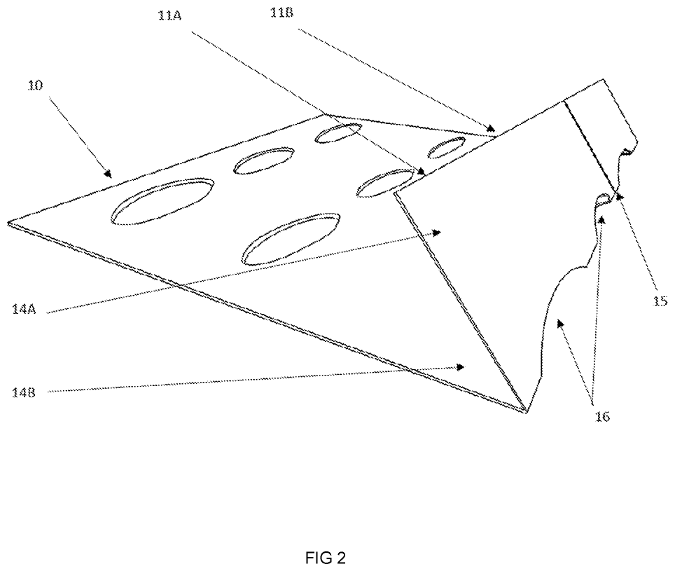

FIG. 2 illustrates a step in the process of forming a floral arrangement apparatus from a blank 10 according to an embodiment of the present invention. In this Figure the first panel portions 14A on each of the elongate members 11A, 11B, 11C (obscure) are folded relative to the second panel portions 14B about the common edge 15 between the first panel portions 14A and the second panel portions 14B.

By folding the panel portions 14A and 14B in this way, the common edge 15 between the first panel portion 14A and the second panel portion 14B forms an outer surface of the floral arrangement apparatus, thereby causing the cavity (obscured) within the blank 10 to be exposed through the apertures 16 along the common edge 15.

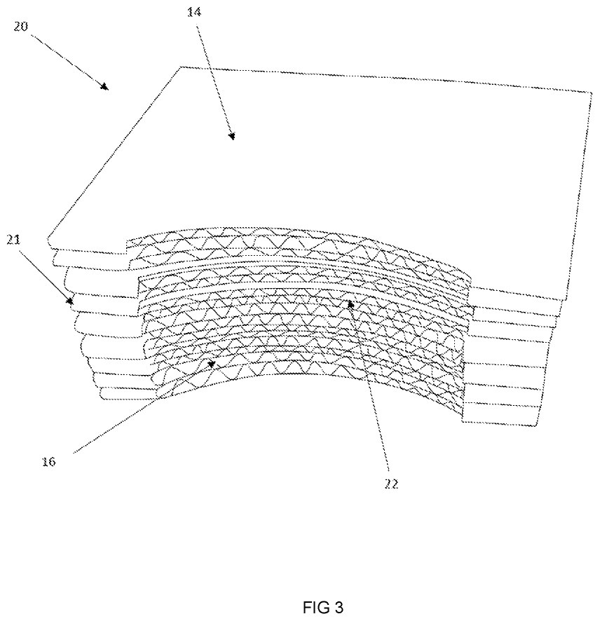

FIG. 3 illustrates a floral arrangement apparatus 20 according to an embodiment of the present invention. In this embodiment of the invention, the panel portions 14 have been folded to be in face-to-face abutment with one another. In this way, the periphery of the panel portions 14 forms the periphery of the floral arrangement apparatus 20. In this way, the midpoint of each panel portion 14 lies substantially on a common axis.

The panel portions 14 of the floral arrangement apparatus 20 are substantially square in shape. Thus, in the assembled condition, the floral arrangement apparatus 20 is substantially cubic or cuboid.

The lower face 21 of the floral arrangement apparatus 20 includes the apertures 16 therein. The cavity 22 within each panel portion 14 may be seen through the aperture 16.

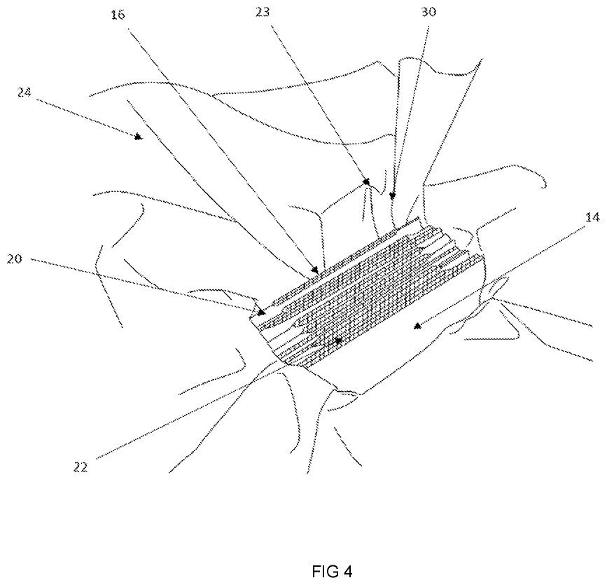

FIG. 4 illustrates a floral arrangement apparatus 20 according to an embodiment of the present invention when in use. The floral arrangement apparatus 20 is located within a container (obscured) such as a vase. The floral arrangement apparatus is retained in a frictional engagement with the edges 23 of the container. In this way, the floral arrangement apparatus 20 is substantially precluded from unfolding from the assembled condition.

In FIG. 4, a layer of tissue paper 24 is placed between the floral arrangement apparatus 20 and the edges 23 of the container. While this may serve a decorative purpose, the tissue paper 24 may also enhance the frictional engagement between the floral arrangement apparatus 20 and the container.

The floral arrangement apparatus 20 is positioned in the container such that the upper face 30 is facing generally upwards. In this way, the apertures 16 are located facing upwardly so that the cavity 22 within each panel portion 14 is exposed. A user may then insert objects (such as the stems or stalks of flora) into the cavities 22 to form a floral arrangement.

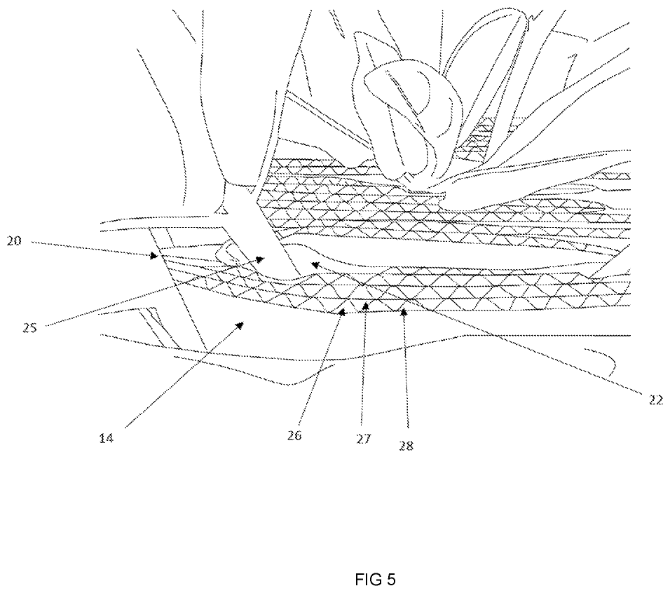

FIG. 5 illustrates a floral arrangement apparatus 20 according to an embodiment of the present invention when in use. In this Figure, stems 25 of various flora are inserted in the cavities 22 in the panel portions 14. The stems 25 are typically of greater diameter than the initial width of the cavities 22, meaning that the stems 25 are retained in frictional engagement with the inner surfaces of the cavities 22.

It may be seen in FIG. 5 that each panel portion 14 is formed from a single wall cardboard comprising a pair of outer layers 26, 27 spaced apart from one another by fluted material 28.

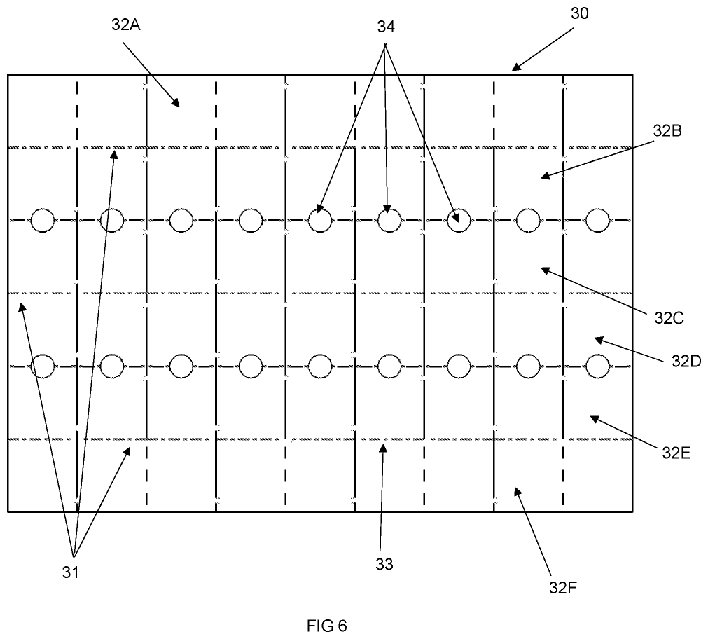

FIG. 6 illustrates a blank 30 for forming a floral arrangement apparatus according to an alternative embodiment of the present invention. The blank 30 is similar to the blank illustrated in FIG. 1, with the exception that the common edges 31 between adjacent elongate members 32A, 32B, 32C, 32D, 32E, 32F include perforations 33.

The presence of the perforations 33 along the common edges 31 between adjacent elongate members 32A, 32B, 32C, 32D, 32E, 32F allows a user to separate the blank 30 into a number of smaller floral arrangement apparatuses by separating elongate members 32A, 32B, 32C, 32D, 32E, 32F from one another cutting, ripping or tearing the blank 30 along the common edges 31.

By separating the elongate members 32A, 32B, 32C, 32D, 32E, 32F from one another a user may, as previously stated, form a plurality of floral arrangement apparatuses (or space-filling and packing devices) from a single blank 30. Alternatively, the user could remove at least one of the elongate members 32A, 32B, 32C, 32D, 32E, 32F from the blank by cutting, ripping or tearing the blank 30 along the common edges 31 in order to reduce the size and/or change the shape of the blank 30 so as to produce a floral arrangement apparatus (or space-filling and packing device) having a reduced overall size, or a shape that is more suited to the vessel in which the a floral arrangement apparatus (or space-filling and packing device) is to be used.

Every second common edge 31 between the elongate members 32A, 32B, 32C, 32D, 32E, 32F is provided with an aperture 34 stamped or punched out of the blank 30. It may be seen that apertures 34 are not present along the common edges 31 between elongate members 32A and 32B, between elongate members 32C and 32D, and between elongate members 32E and 32F. However, by separating the elongate members 32A, 32B, 32C, 32D, 32E, 32F along the common edges 31, apertures are formed in the common edges 31 through which cavities in the elongate members 32A, 32B, 32C, 32D, 32E, 32F may be accessed.

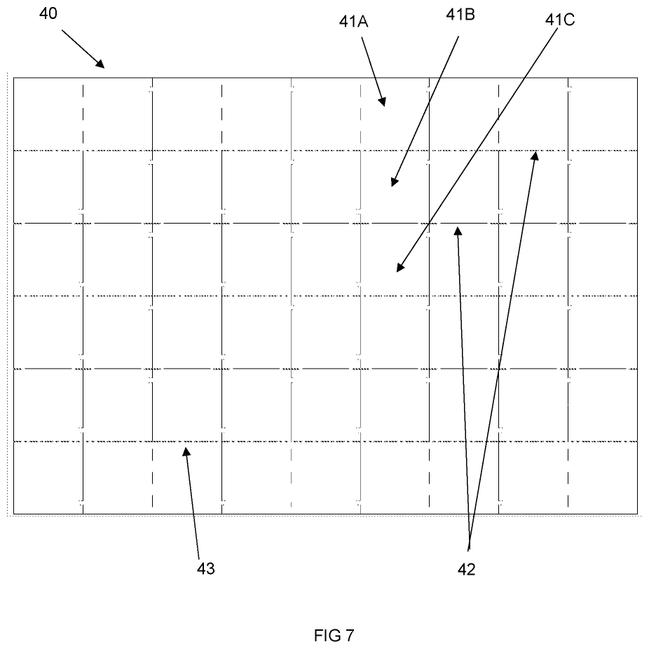

FIG. 7 illustrates a blank 40 for forming a space-filling and packing device according to an embodiment of the present invention. The blank 40 illustrated in FIG. 7 has similar features as the blanks illustrated in FIG. 1 and FIG. 6. However, the blank 40 illustrated in FIG. 7 is configured to be a space-filling and packaging device when assembled.

The blank 40 is assembled into the space-filling and packaging device in much the same way that the blanks illustrated in FIGS. 1 and 7 are assembled into a floral arrangement apparatus (i.e., by folding panel portions 41A, 41B, 41C relative to one another along common edges 42 between adjacent panel portions 41, 41B, 41C). As with the blank illustrated in FIG. 6, at least some of the common edges 42 are provided with perforations 43 that allow adjacent rows of panel portions 41A, 41B, 41C to be separated from one another in order to change the size and/or shape of the assembled space-filling and packaging device.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

Those skilled in the art will appreciate that various adaptations and modifications of the embodiments described above can be configured without departing from the scope and spirit of the invention. Therefore, it is to be understood that, within the scope of the appended claims, the invention may be practiced other than as specifically described herein.

1. A blank when used for forming a floral arrangement apparatus, the blank being fabricated from a material comprising at least a pair of layers spaced apart from one another to form a cavity therebetween, the blank comprising a first panel portion and a second panel portion located adjacent the first panel portion and sharing a common edge therewith, the first panel portion and the second panel portion being configured for folding movement relative to one another about the common edge, wherein, in the assembled condition, the first panel portion and the second panel portion are located in abutment with one another such that the cavity is accessible through an aperture in the common edge.

2. The blank according to claim 1, wherein the material comprises a single wall cardboard or a double wall cardboard.

3. The blank according to claim 2, wherein the cardboard is fabricated from a natural cellulosic material.

4. The blank according to claim 1, wherein the common edge between the first panel portion and the second panel portion is defined by a crease or a score line.

5. The blank according to claim 1, wherein the blank comprises a third panel portion located adjacent the second panel portion and sharing a common edge therebetween.

6. The blank according to claim 5, wherein the common edge between the second panel portion and the third panel portion is located substantially parallel to the common edge between the first panel portion and the second panel portion.

7. The blank according to claim 1, wherein the blank comprises two or more elongate members, each of the two or more elongate members being formed from two or more panel portions.

8. The blank according to claim 7, wherein a first elongate member is located adjacent a second elongate member and shares a common edge therewith, wherein the first elongate member and the second elongate member are configured for folding movement relative to one another about the common edge.

9. The blank according to claim 8, wherein the common edge between the first elongate member and the second elongate member is substantially perpendicular to the common edges between the panel portions.

10. The blank according to claim 7, wherein the first elongate member and the second elongate member comprise an equal number of panel portions.

11. The blank according to claim 1, wherein each of the first panel portion and the second panel portion is configured to fold approximately 90° relative to its position in the blank such that, in the assembled condition, the first panel portion and the second panel portion are located in abutment with one another.

12. The blank according to claim 1, wherein, in the assembled condition, the panel portions are in alignment with one another such that a periphery of the first panel portion is aligned with all other panel portions.

13. The blank according to claim 12, wherein, in the assembled condition, the periphery of the panel portions together form a periphery of the floral arrangement apparatus.

14. The blank according to claim 13, wherein the aperture is located on the periphery of the floral arrangement apparatus.

15. The blank according to claim 1, wherein the cavity is a discrete cavity.

16. The blank according to claim 1, wherein the common edges include perforations.

17. The blank according to claim 1, wherein, in the assembled condition, a floral arrangement is arranged by inserting components of the floral arrangement into the cavity within the panel portions.

18. A floral arrangement apparatus assembled from the blank of claim 1.

19. A space-filling and packaging device assembled from the blank of claim 1.

20. A floral arrangement apparatus comprising a plurality of panel portions located in substantial alignment with one another, such that a periphery of each of the panel portions forms a periphery of the floral arrangement apparatus, each panel portion being fabricated from a material comprising at least a pair of layers spaced apart from one another to form a cavity therebetween, and wherein an aperture is provided in the periphery of at least a portion of the plurality of panel portions, such that the cavity in each of the panel portions is accessible through the aperture.

21. The floral arrangement apparatus according to claim 20, wherein a floral arrangement is arranged by inserting components of the floral arrangement into the cavity within the panel portions.

22. The floral arrangement apparatus according to claim 20, wherein the floral arrangement apparatus is located within a container for use.

23. The floral arrangement apparatus according to claim 20, wherein material from which the floral arrangement apparatus is fabricated is water resistant or waterproof.

24. The floral arrangement apparatus according to claim 20, wherein the floral arrangement apparatus is provided with one or more substances configured to extend the life of a floral arrangement.

25. The floral arrangement apparatus according to claim 24, wherein the one or more substances configured to extend the life of the floral arrangement comprise fertilisers, flower food or colour enhancers.

26. The floral arrangement apparatus according to claim 24 wherein the one or more substances configured to extend the life of the floral arrangement are located within the cavity or are impregnated into, or coated onto, the apparatus.

27. A space-filling or packing device, the device comprising a plurality of panel portions located in substantial alignment with one another, such that a periphery of each of the panel portions forms a periphery of the device, each panel portion being fabricated from a material comprising at least a pair of layers spaced apart from one another to form a cavity therebetween, and wherein an aperture is provided in the periphery of at least a portion of the plurality of panel portions, such that the cavity in each of the panel portions is accessible through the aperture.
